(19) United States
(12) Patent Application Publication
(10) Pub. No.: US 2015/0379305 A1
(43) Pub. Date: Dec. 31, 2015

(54) Digitised Handwritten Signature Authentication

(71) Applicant: COMPAGNIE INDUSTRIELLE ET FINANCIERE D'INGENIERIE "INGENICO", Paris (FR)

(72) Inventor: Philippe Cece, Evette-Salbert (FR)

(73) Assignee: INGENICO GROUP, Paris (FR)

(21) Appl. No.: 14/766,544

(22) PCT Filed: Feb. 7, 2014
(86) PCT No.: PCT/EP2014/052498

§ 371 Date: Aug. 7, 2015

(30) Foreign Application Priority Data
Feb. 8, 2013 (FR) 1351087

(51) Int. Cl. G06F 21/64; G06F 17/30; H04L 29/08

(52) U.S. Cl. CPC G06F 21/64; H04L 67/10; G06F 17/30528

(57) ABSTRACT

A method is provided for creating a contextualized, digitized signature, which is representative of a signature made by a user on a signature input device for a given action. The method includes: obtaining at least one piece of data relative to a context; obtaining a signature, delivering a digitized signature; and combining the digitized signature and the at least one piece of context data, delivering the contextualized, digitized signature.

### 1. CROSS-REFERENCE TO RELATED APPLICATIONS

This Application is a Section 371 National Stage Application of International Application No. PCT/EP2014/052498, filed Feb. 7, 2014, which is incorporated by reference in its entirety and published as WO 2014/122297 on Aug. 14, 2014, not in English.

### 2. FIELD OF THE INVENTION

The invention relates to the field of authentication. More particularly, the invention relates to the field of the authentication of handwritten signatures.

### 3. PRIOR ART

In certain sales deeds, contractual documents or subscription documents, the undertaking party or subscriber is required to affix a handwritten signature. To facilitate the management of these documents, it is increasingly common to directly or subsequently dematerialize (or virtualize) the documents as well as the signature, through the use of biometric or non-biometric data so as to keep only a digital carrier.

Thus, from a legal and often psychological viewpoint, it is always necessary to have available a handwritten signature on a certain number of documents. There is therefore a need to propose a solution that enables compliance with legal requirements and reassures users wishing to see the appearance of a handwritten signature while at the same time ensuring that this signature complies with the provisions of 1999/93/EC directive.

There are known methods and devices in the prior art that are used to enter the signature of an individual on to an information-processing carrier. Such devices are for example used by postal employees or by transporters to validate the reception, by an addressee, of a package or an envelope that is to be delivered by hand. The use of such signature devices replaces paper delivery receipts by electronic delivery receipts. Such electronic receipts simplify the management of acknowledgements of receipt for organizations that use such methods. By contrast, as far as security is concerned, the existing devices do not perform well. These devices indeed are not made to take account of the legal requirements of signature authentication. On the contrary, the only function of existing devices is to take a signature and digitize it. Since the goal of these devices is to replace a paper signature by a digitized signature, the securing of these signatures is only rarely taken into account.

Conversely, for the securing of electronic exchanges (such as for example exchanges between a customer and a server), there are numerous mechanisms that ensure that the information exchanged is confidential. These mechanisms are implemented by means of asymmetrical keys or shared keys. Using these keys, the information is exchanged in encrypted form. Naturally, there are numerous variations and numerous methods to make sure that only the holder of a key or a pair of keys is capable of encrypting or decrypting a piece of information. These mechanisms make it possible especially to implement a signature called a “digital” signature (legally called an electronic signature) on documents. As a rule, a digital signature ensures the integrity of an electronic document and authenticates its author. A digital signature has characteristics that enable the reader of a document to identify the person or organization who has placed his signature and who ensures that the document has not been altered between the time when the author has signed it and the time when the reader consults it. The following are the characteristics to be brought together so that a digital signature may comply with expectations: the authenticity of the identity of signing party, the non-falsifiable character of the signature, the impossibility of using the signature for another document, the inability of the signed document to be altered and the irrevocability of the signature.

Now, given the state of the prior art, these characteristics are not often brought together in present-day devices for entering handwritten signatures. Thus, few existing devices enable an entry of handwritten signatures meeting the above characteristics. Some existing systems claim to be capable of providing a digitized hardware signature that is compliant with the European Parliament directive and the directive of the European Council dated 13 Dec. 1999 (1999/93/EC). This is for the case for example with the Wacom™ firm. However, existing systems, including those by Wacom™, require the use of a complementary external device (called a signature pad). Besides, as explained by Wacom™, communications with the Wacom™ device can be controlled by means of a framework which is known to all and which makes it possible at the very least to develop a malicious software program to access the device. There is therefore a security flaw in current systems. In addition, current systems offer “plain text” or “visible” access to the biometric data produced (these are the customers' signatures). This is contrary to the provisions of the European directive 95/46/CE, which stipulates that such biometric data should not be subject to uncontrolled dissemination

### 4. SUMMARY OF THE INVENTION

The invention does not have these problems of the prior art. Indeed, the invention makes it possible to both provide a digitized handwritten signature while at the same time providing the properties needed for its validation according to legal requirements.

More particular, the invention takes the form of a method for creating a digitized signature. According to the invention, such a method comprises:
a step for entering a signature delivering a digitized signature;
a step for obtaining at least one piece of data pertaining to a context associated with said digitized signature;
a step for combining said digitized signature and said at least one piece of context data delivering a contextualized signature.

Thus, the invention makes it possible to combine, in only one signature, elements to clearly identify the object of this signature. The object of the signature is therefore linked unalterably to the signature itself. Besides, since the image can be printed, the invention also makes possible to have physical proof of the signature of the deed in addition to digital proof.

According to the invention, the above-mentioned method is implemented within a secured enclosure. Such a secured enclosure can for example take the form of a secured terminal, such as a payment terminal which comprises a device or a mechanism for digitizing handwritten signatures.

According to one particular characteristic, said step for obtaining at least one piece of data relating to a context comprises at least one step for obtaining a random piece of data.

Since the random piece of data is obtained at the time when the context data is obtained, it is also related to the deed. This means that an attacker wishing to usurp the signature must also retrieve this piece of random data, which is a very complicated task.

According to one particular characteristic, said step for obtaining said piece of random data comprises at least one step for computing a piece of data representing a random image background.

According to one particular characteristic, said step for computing said piece of data representing a random image background comprises a step for applying a random noise to an original image.

According to one particular embodiment, said step for obtaining a signature furthermore comprises a step for obtaining at least one piece of biometric data of said user.

Thus, this piece of biometric data can be used in the framework of the creation of context. The step for obtaining the signature also comprises a step for obtaining a digitized image and other parameters such as for example the method used to capture the signature.

According to one particular embodiment, said method furthermore comprises:
a step for computing at least one piece of concealed data by means of said at least one piece of data pertaining to a context and said at least one digitized signature;
a step for inserting said at least one piece of concealed data into said contextualized signature.

According to one particular embodiment, the piece of biometric data previously obtained can be used to compute the piece of concealed data, thus making it almost impossible to falsify the signature.

According to one particular embodiment, said step for inserting said at least one piece of concealed data within said contextualized signature comprises a step for computing a digital watermark from said at least one piece of concealed data and said step for inserting said at least one piece of concealed data consists of the application, within said contextualized signature, of said digital watermark.

According to one particular embodiment, said step for inserting within said contextualized signature consists in inserting said at least one piece of concealed data within metadata of said contextualized signature.

The invention also relates to a device for creating a contextualized digital signature representing a signature made by a user.

According to the invention, such a device comprises:
means for obtaining at least one piece of data relating to a context;
means for obtaining a signature delivering a digitized signature;
means for combining said digitized signature and said at least one piece of context data delivering a contextualized signature.

According to one preferred implementation, the different steps of the methods according to the invention are implemented by one or more software programs or computer programs comprising software instructions to be executed by a data processor of a relay module according to the invention and designed to control the execution of the different steps of the methods.

Consequently, the invention also pertains to a program capable of being executed by a computer or by a data processor, this program comprising instructions to control the execution of the steps of a method as mentioned here above.

This program can use any programming language whatsoever and can take the form of source code, object code or a code that is an intermediate code between source code and object code such as in a partially compiled form or in any other desirable form whatsoever.

The invention is also aimed at providing an information carrier readable by a data processor, and comprising instructions for a program as mentioned here above.

The information carrier can be any entity or device whatsoever capable of storing the program. For example, the medium can comprise a storage means such as a ROM, for example a CD ROM or a microelectronic circuit ROM or again a magnetic recording means such as floppy disk or a hard disk drive.

Besides, the information carrier can be a transmissible carrier such as an electrical or optical signal, which can be conveyed via an electrical or optical cable, by radio or by other means. The program according to the invention can especially be uploaded to an Internet type network.

As an alternative, the information carrier can be an integrated circuit into which the program is incorporated, the circuit being adapted to executing or to being used in the execution of the method in question.

According to one embodiment, the invention is implemented by means of software and/or hardware components. In this respect, the term “module” in this document can correspond equally well to a software component as to a hardware component or to a set of hardware or software components.

A software component corresponds to one or more computer programs or several sub-programs of a program or more generally to any element of a program or a software package capable of implementing a function or a set of functions, according to what is described here below for the module concerned. Such a software component is executed by a data processor of a physical entity (terminal, server, gateway, router, etc) and is capable of accessing hardware resources of this physical entity (memories, recording media, communications buses, input/output electronic boards, user interfaces, etc).

In the same way, a hardware component corresponds to any element of a hardware assembly capable of implementing a function or a set of functions according to what is described here below for the module concerned. It may be a programmable hardware component or a component with an integrated processor for the execution of software, for example an integrated circuit, a smartcard, a memory card, an electronic card for executing firmware, etc.

Naturally, each component of the system described here above implements its own software modules

The different embodiments mentioned here above can be combined with one another to implement the invention.

### 5. FIGURES

Other features and advantages of the invention shall appear more clearly from the following description of a preferred embodiment, given by way of a simple, illustratory and non-exhaustive example, and from the appended drawings, of which:

FIG. 1 is an example of a contextualized signature as understood in the invention;

FIG. 2 describes the method for creating a contextualized signature as understood in the invention;

FIG. 3 describes a method for verifying a contextualized signature as understood in the invention;

FIG. 4 illustrates a method for furnishing proof of signature as understood in the invention;

FIG. 5 illustrates a device capable of creating a contextualized signature.

### 6. DESCRIPTION OF ONE EMBODIMENT

### 6.1. Reminder of the Principle of the Invention

As explained here above, it has been observed that the current solutions are not capable of really ensuring the authenticity of the digitized handwritten signatures for a given deed and moreover do not ensure the confidentiality of the user's personal data (for example his biometric data). To date, the virtualization of a signature commonly corresponds to an image. Hence, a merchant or any other party who is ill-intentioned can copy this signature in order to affix it to another contract or to a modification of the contract or can use this signature obtained in the context of any other operation. Besides, in this case of the virtualization of signatures with biometric data, the biometric signature acquisition systems provide all the data to a third-party software program that is executed on a non-secured system. Thus, it is possible for virus type software programs to retrieve this personal information and use it for fraudulent purposes.

The invention makes it possible to settle and confirm the association of the signatory's signature with elements identifying the contractual document concerned within the secured equipment inalterably so as to prevent the above-mentioned flaws.

In general, the invention relates to the signature in itself, the method of its creation and to methods used to verify the validity of these signatures. To ensure trust and security between the two parties, the inventors propose the use of an apparatus provided with a device for the digital acquisition of the signature with or without biometric data as well as a cryptographic enclosure enabling it to perform algorithms based on one or more secret and/or asymmetric keys. More particularly, the inventors propose the use of card payment terminals and the capture of signatures corresponding for example to the PCI-PTS standards. Thus, it is not necessary to have available a third-party apparatus to capture the signature and therefore only one apparatus with a security and signature-capture function is sufficient. An existing apparatus can be used (if it has a signature capture/recording device). This has several advantages. The first advantage is that of not depending on one particular hardware supplier. Payment terminals that meet, for example, the PCI-PTS standards are indeed available from several manufacturers. The proposed method is compatible with these terminals. The second advantage is that of having available a highly secured terminal (relative to the terminals of the specialized companies). Indeed, the pads of the specialized companies are adapted to conventional use. These pads do not have the same security measures as for example those of PCI-PTS payment terminals (which include ant-intrusion mechanisms, memory-erasure mechanisms, cryptographic algorithmic keys, etc.). Thus, to date, it is possible to have a dialogue with an existing pad in order for example to obtain the cryptographic keys needed to encrypt the signature (to enable the production of false signatures thereafter) or to obtain an original digitization of an existing signature.

However, the use for example of a PCI-PTS terminal guarantees that this type of problem cannot arise. Thus, according to the invention, when requesting a signature, the apparatus (for example the PCI-PTS terminal) receives data pertaining to the deed or document (of sale, contract or subscription). The apparatus computes a certificate of operation pertaining to this data and then acquires the signature. Naturally, the use of a PCI-PTS terminal can be replaced by that of another type of terminal provided that this terminal firstly secures the data entered and secondly comprises means for detecting intrusion and/or fraud.

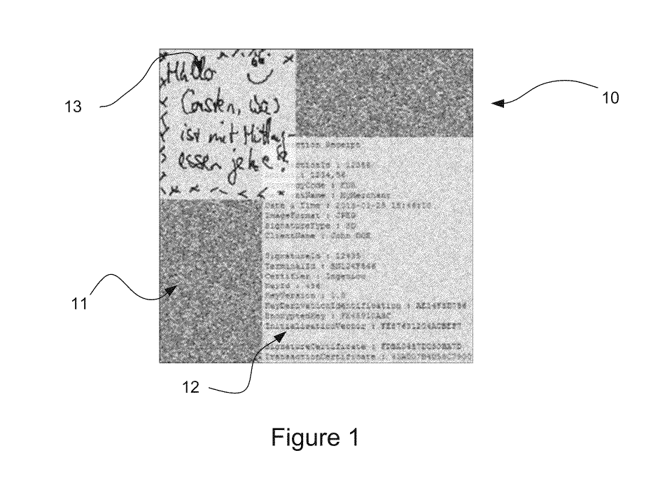

To enable the certification of the signature at the point of sales, contract or subscription, the terminal provides a contextual signature of the deed or document (of purchase, contract or subscription) in the form of a contextualized image (this is a specific image as will be shown here below). The enormous advantage is that this image can be printed and can serve as a payment ticket. In certain embodiments, this payment ticket can also serve as subsequent proof. This signature is described with reference to FIG. 1.

The general certificate 10 (or contextualized certificate or contextualized image) comprises a random element 11 (for example a random background (for example of the white noise type commonly called snow)) on which at least two other images are superimposed. The first image 12 comprises data on the document (this is a context or contextual data) combined in one certificate called an operation certificate computed by the equipment and incontestably identifying this document. This first image 12 can also contain all the data needed to verify this certificate of operation and, if necessary, legal information on use pertaining to the contextualized signature.

The second image 13 comprises a graphic rendering of the signature.

Finally, all or part of the data received or acquired by the apparatus at the time of the deed as well as the certificate of operation (the data serving to identify the deed such as identifiers, amounts, dates and times, etc.), the data serving for its control and optionally the legal information on terms of use can be encrypted or concealed or recorded in the contextualized signature. The biometric parameters of the signature collected can form part of this data thus integrated or concealed. This data is invisible (and therefore not shown in FIG. 1). It can take the form of either a digital watermark or metadata included in the image.

The final contextualized image provided by the apparatus thus constitutes an electronic signature as understood in the directive of the European Parliament and of the European Council dated 13 Dec. 1999 (1999/13/EC).

Indeed, the identity of the provider of the deed, also called the contractual partner, is guaranteed by the use of a terminal and the identity of the subscriber, also called the signatory, is guaranteed by his signature, of which he is the only person to hold the means of producing this signature. The integrity of the contextualized signature is guaranteed by the certificate of operation and the data of the handwritten signature present and recorded in the image. In addition, for the use of biometric data, the protection of this biometric data (which is personal data) is complied with by encryption in accordance with the European directive 95/46/EC.

Consequently, the invention does not require an uncontrolled third-party system (i.e. a third-party system which is not a trusted party) to produce a contextualized signature which has the value of an electronic signature as understood in the directive 99/13/EC. By contrast, according to the invention, as explained here below, the presence of a trusted third party can be useful to establish proof of the signature in the event of dispute.

This image is transmitted to a requesting device or third party, if necessary, with a view to printing, saving or archival storage.

### 6.2. Creation of the Contextualized Signature

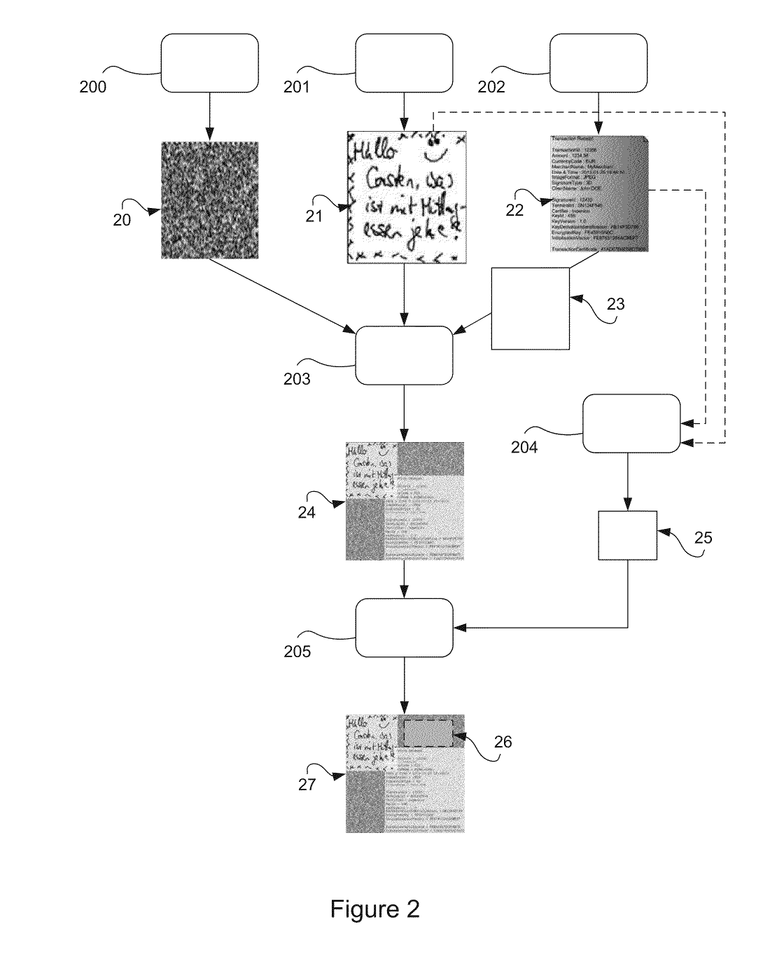

Referring to FIG. 2, we present the different steps that lead to the creation of a contextualized signature as understood in the invention. It may be recalled that a contextualized signature is a signature linked to a given deed or document, whether it is a deed or document of purchase, sale or subscription. More generally, a contextualized signature is a signature attached to a contract or to a commitment.

According to the invention, in this embodiment, the creation of a contextualized signature comprises a step 200 for obtaining a random image 20 (in one particular embodiment, the random image is a white background image to which a random monochrome noise is applied, itself defined by a random factor in the form of an alphanumerical sequence of characters). Once this random image has been obtained, the method comprises a step 201 for obtaining a digitized signature 21. The step 21 for obtaining comprises either the entry of the signature by a user on the terminal and/or the obtaining of a signature file (SIG file containing biometric data). The step for obtaining a signature also comprises a step for obtaining a digitized image and/or other parameters such as for example the method used to carry out a capture (2D, 3D, sampling rate, etc.). The method also comprises a step 202 for obtaining transaction data 22 (or transactional data). This transactional data corresponds to the context for which the signature is made. Should it be a purchase, this transactional data comprises for example the vendor's identifier, the date and time, the amount of the transaction, the customer's identifier (signatory), the type of signature made to validate the transaction.

This last-mentioned characteristic is directly related to context. Indeed, depending on the terminals, it is possible to pick up a signature according to various methods. Certain captures can be made only in two dimensions. Other signatures can be captured in three dimensions. Since the tradesman (or holder of the terminal) knows the type of signature that is being picked up by the terminal, this type of signature, according to the invention, is integrated into the transactional data. This makes it possible to link the signature even more strongly to a particular context.

The following step consists in merging 203 the random image 20, the signature 21 and a graphic representation 23 of the transactional data 22 in one and the same combined image 24. This combined image 24, according to a first embodiment, forms the contextualized signature as understood in the invention. According to one particular characteristic, the method furthermore comprises a step 204 for building concealed data 25 and a step 205 for the insertion, in the form of a digital watermark 26 (or metadata), of concealed data in the combined image 24 to form a watermarked image 27. In this second embodiment, the watermarked image 27 forms the contextualized signature.

According to one particular characteristic, the concealed data 25 comprises biometric data and/or transactional data and/or image building data (for example the digital string representing the random element used). The biometric data are pieces of data representing the captured signature 21. Depending on the method used to capture the data (for example 3D signature capture or 3D capture with or without data on pressure), the biometric data comprise information different in various degrees. Thus, according to the invention, the pieces of biometric data are integrated into the contextualized signature. However, to comply with the legislation in force (the directive 95/46/EC especially), this biometric data is not only concealed but, in addition, is not integrated “in plain” or visibly into the signature. On the contrary, the biometric data is encrypted prior to its integration in concealed form in the contextualized signature. More specifically, the concealed data is preliminarily encrypted by using the cryptographic material of the terminal (for example the payment terminal when this type of terminal is used). Since the terminal is protected and secured, it is thus ensured that only the holder of the cryptographic material of the terminal (the holder of the cryptographic equipment is for example the manufacturer of the terminal) can decrypt this encrypted data and meet the requirements of authentication which can arise at the end of the signing process.

### 6.3. Determining of Proof of the Deed

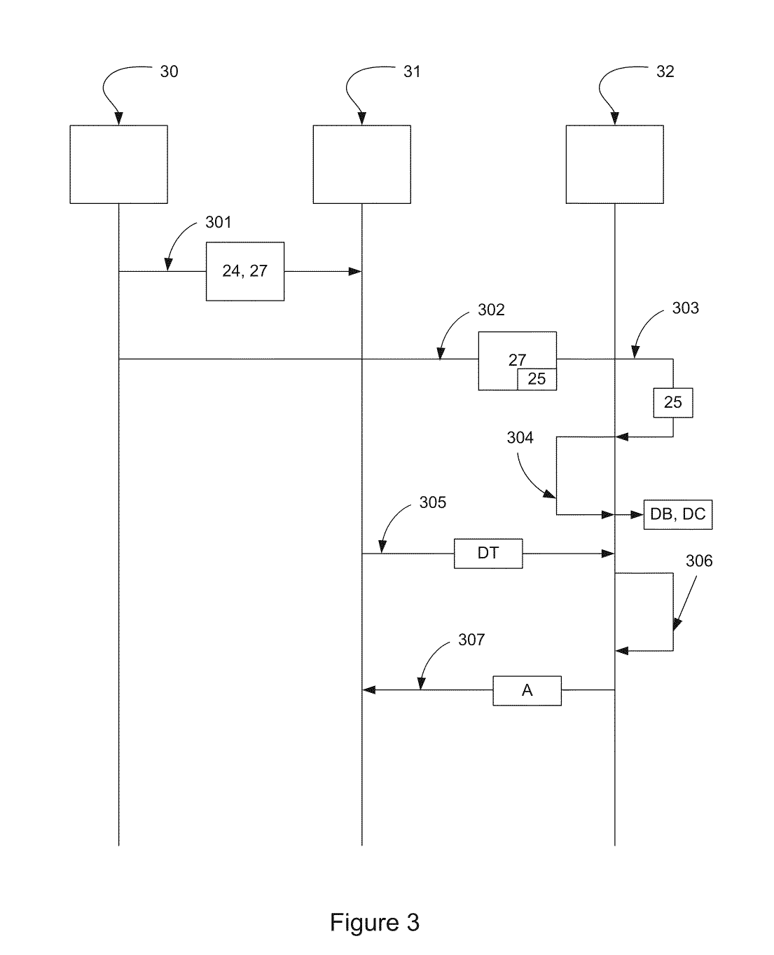

After the contextualized signature has been created, two situations can arise. The first situation is the request, transmitted by a requesting third-party establishment, tending to obtain proof of signature by the contracting party (this for example can be proof of payment required by a bank). According to the invention, this request is met by the transmission of an assertion of validation of the contextualized signature. The method of issuing this assertion is described with reference to FIG. 3.

Two possible instances can occur in this first situation. In the first instance 301, the contractual partner 30 (for example the merchant), directly uses the secured image file (this is the contextualized signature 24, 27) in his possession. In this case, he can transmit it to the requesting party 31 (for example a financial institution that wishes to obtain proof of purchase or of the deed). In the second example, if the financial establishment 31 wishes to have proof of authenticity of this contextualized signature 27, the contractual partner 30 who has this contextualized signature 27 available, transmits it 302 to a trusted or trustworthy third party 32 responsible for authenticating it. This trusted third party 32 will, on the basis of this contextualized signature 27 alone, carry out the operations needed to recreate the signature. In this embodiment, the trusted third party 32 is deemed to be in possession of the cryptographic equipment needed for decrypting the concealed data 25 of the contextualized signature 27 (for example the trusted third party possesses the private key used to encrypt the concealed data 25). This trusted third party 32 can be the builder of the terminal that has been used to build the contextualized signature.

In this embodiment of the invention, the following step is a step 303 for extracting concealed data 25 followed by a step 304 for decrypting the concealed data 25 delivering biometric data and contextual data (DB-DC). The requesting party 31 transmits 305, for his part, the transactional data (DT) in his possession. At least some of the data (DB-DC) is then compared 306 with at least some of the transactional data (DT) and an assertion A is transmitted 307 when the data are in agreement. As an alternative, the trusted third party 32 can receive the transactional data DT from the contractual partner 31 (if he possesses it). As an alternative, the trusted third party 32 can already have a copy of the transactional data DT. The invention also pertains to the computer programs and the devices used to implement the method that has just been described.

### 6.4. Checking the Validity of the Contextualized Signature

The second situation is that in which it is necessary to prove that a signature has not been artificially forged, outside the method for creating the contextualized signature and/or that the transactional data has not been modified.

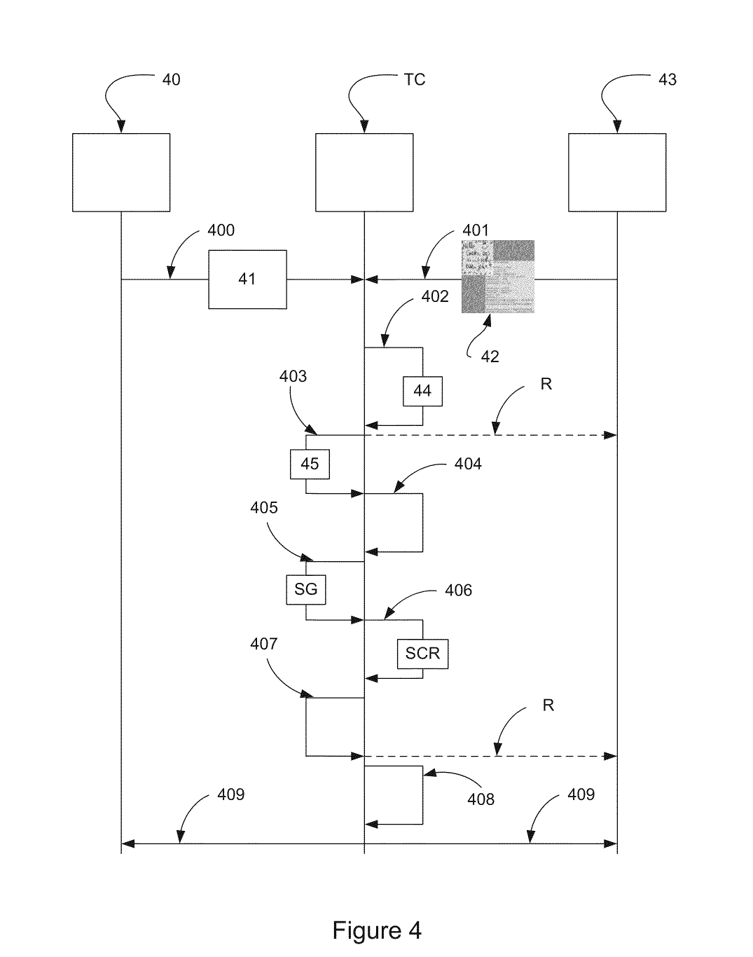

The method of verification is described with reference to FIG. 4.

This method comprises:
a step (400) for receiving transactional data (41) from a custodian or depository (40), by a trusted third party (TC), this transactional data (41) being taken to be the source of the contextualized signature (42) the authenticity of which is to be verified (the custodian can be the merchant, the entity having the quality of a contractual partner or a trusted third party with whom the transactional data is preserved);
a step (401) for receiving the contextualized signature to be verified (42) from a custodian (43. It may be the same custodian but this is not obligatory;
a step (402) for searching, within the contextualized signature to be verified (42) for a digital watermark or for metadata (44) delivering a piece of data on the presence of digital watermarking or metadata; and
   when said piece of data on presence of a digital watermark is positive, a step (403) for obtaining concealed data (45);
   when said piece of data on the presence of a digital watermarking is negative, a step (R) for rejecting said contextualized signature;
a step (404) for checking the concealed data (45); and when certain pieces of said concealed data correspond to at least certain pieces of said corresponding transactional data (41),
   a step 405 for computing a signature, comprising a step for decrypting biometric data, a step for building a signature (SG) from the biometric data included in the decrypted concealed data;
   a step 406 for building a contextualized reference signature (SCR) from said preceding data. The building comprises, if necessary, the implementing of the random factor included in the concealed data;
   a step for comparing said reference signature SCR and said contextualized signature 42;
   when the two signatures are different, a step (R) for rejecting the contextualized signature;
   when the two signatures are identical, a step (408) for checking the authenticity of the biometric data (this verification is done by other means not described herein) and when the biometric data is the right data, a step (409) for transmitting a piece of information on authenticity of the signature.

Thus, as shall be seen clearly from the reading the above, the contextualized signature comprises both a handwritten signature that is visible and directly identifiable by a user and the data needed to rebuild this signature for the subsequent checking of its own authenticity. A remote analogy can be made with a living cell which comprises both its own characteristics and means to duplicate itself to obtain an identical cell. The invention also pertains to computer programs and devices enabling the method that has just been described to be implemented.

### 6.5. Content of the Concealed Data

In one purely illustratory embodiment, the concealed data comprise the following data recordings:
at least one piece of data for identifying the signatory;
at least one piece of data for identifying the contractual partner (for example the merchant, the entity issuing the contract or the deed);
at least one piece of data for dating the signature;
at least one piece of data for identifying the signature;
at least one piece of data for identifying a trusted third party;
a piece of data for identifying an encryption key;
a piece of data for identifying a key version;
a piece of data for identification of a key derivation;
a computerization of a random element (this is for example an alphanumerical sequence of predetermined length);
encrypted biometric data.

It is possible to complement or replace this concealed data by other data which can have relevance depending on a given context.

### 6.6. Device for Creating a Contextualized Signature

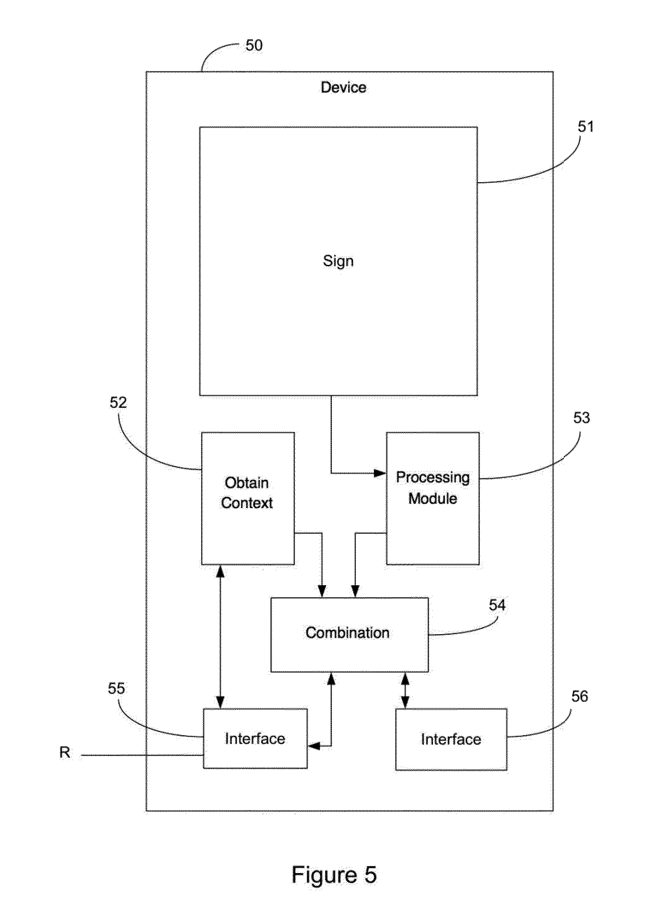

Referring to FIG. 5, we describe a device 50 for creating a contextualized signature as understood in the invention. Such a device comprises signature-capturing means 51. Such means are for example a touch screen capable of recording a signature. It may also be a signature pad dissociated from the display of the entered signature.

Be that as it may, this device comprises:
means 52 for obtaining at least one piece of data pertaining to a context. These means can take the form of a software or hardware module or again a network module for the reception of information from another device. It can also be all these means together to enable the data coming from several sources to be combined.
means 51 for entering a signature delivering a digitized signature, namely means incorporating means for obtaining biometric data (i.e. from the signature performed; the pieces of biometric data are computed by these signature entry means) or these means are solely responsible for the capture of data which must then be processed and analyzed by another module 53 to produce the biometric data.
means 54 for combining said digitized signature and said at least one piece of contextual data delivering a contextualized signature. These means for combining, which are integrated into the device, comprise for example secured memories comprising encryption keys, means for generating random values when necessary, means of encryption, means for formatting data, etc. These means can be software modules implemented by a processor, hardware modules, for example programmable hardware modules, or again a specialized processor performing all these tasks.

Besides, the device furthermore comprises interfaces (55, 56), for example network interfaces R enabling the transmission and reception of computer data to other devices such as servers to enable firstly the reception of requests for furnishing contextualized signatures, the transmission of such signatures of context alone, etc.

Although the present disclosure has been described with reference to one or more examples, workers skilled in the art will recognize that changes may be made in form and detail without departing from the scope of the disclosure and/or the appended claims.

1. A method comprising:
creating a contextualized, digitized signature representing a signature made by a user on a device for entering signatures for a given deed, wherein creating comprises:
obtaining at least one piece of data pertaining to a context, comprising obtaining a piece of random data representing a random background image;
obtaining the signature from the user through the device, delivering a digitized signature; and
combining said digitized signature and said at least one piece of context data delivering the contextualized, digitized signature.

2. The method according to claim 1, wherein obtaining said piece of random data comprises computing said piece of data representing the random background image by applying a random noise to an original image.

3. The method according to claim 1, wherein obtaining a signature furthermore comprises obtaining at least one piece of biometric data of said user.

4. The method according to claim 1, wherein the method further comprises:
computing at least one piece of concealed data by using said at least one piece of data pertaining to a context and said at least one digitized signature;
inserting said at least one piece of concealed data into said contextualized signature;

5. The method according to claim 4, wherein inserting said at least one piece of concealed data into said contextualized signature comprises computing a digital watermark from said at least one piece of concealed data, and inserting said at least one piece of concealed data comprises applying, within said contextualized signature, said digital watermark.

6. The method according to claim 4, wherein said inserting into said contextualized signature comprises inserting said at least one piece of concealed data into metadata of said contextualized signature.

7. A device for creating a contextualized digital signature representing a signature made by a user, wherein the device comprises:
means for obtaining at least one piece of data relating to a context;
means for obtaining the signature of the user, delivering a digitized signature; and
means for combining said digitized signature and said at least one piece of context data, delivering the contextualized, digitized signature.

8. A non-transitory computer-readable medium comprising a computer program product stored thereon and executable by a processor, wherein the program product comprises program code instructions, which when executed by a processor implement a method comprising:
creating a contextualized, digitized signature representing a signature made by a user on a device for entering signatures for a given deed, wherein creating comprises:
obtaining at least one piece of data pertaining to a context, comprising obtaining a piece of random data representing a random background image;
obtaining the signature from the user through the device, delivering a digitized signature; and
combining said digitized signature and said at least one piece of context data delivering the contextualized, digitized signature.
